(19) United States
(12) Patent Application Publication
(10) Pub. No.: US 2018/0264703 A1
(43) Pub. Date: Sep. 20, 2018

(54) METHOD FOR FORMING RESIN FILM

(71) Applicant: TOYOTA JIDOSHA KABUSHIKI KAISHA, Toyota-Shi (JP)

(72) Inventors: Tatsuo Hoshino, Chiryu-shi (JP); Yasuhiro Akita, Nagoya-shi (JP)

(73) Assignee: TOYOTA JIDOSHA KABUSHIKI KAISHA, Toyota-Shi (JP)

(21) Appl. No.: 15/923,753

(22) Filed: Mar. 16, 2018

(30) Foreign Application Priority Data
Mar. 17, 2017 (JP) 2017-052074

(51) Int. Cl. B29C 47/88; B29C 47/00; B29C 47/14; B29C 47/92

(52) U.S. Cl. CPC B29C 47/8845; B29C 47/0021; B29C 47/14; B29C 2947/926; B29C 2947/92447; B29C 2947/92571; B29C 47/92

(57) ABSTRACT

Provided is a method for forming resin film capable maximizing the effective width of the resin film while suppressing neck-in and so increasing the material utilization. The method includes: drawing molten resin extruded downward from a die exit by a cooling roll; blowing air to both ends of the molten resin from an air-blowing nozzle to cure the both ends of the molten resin while cooling the molten resin on a surface of the cooling roll for solidification. For an effective width of the resin film to be formed having a thickness in a predetermined thickness range, a target effective width is set. An amount of air to be blown and a distance from the air-blowing nozzle to the molten resin are set to form the resin film having an effective width of the target effective width or more. The resin film is formed while blowing air under the conditions.

### CROSS REFERENCE TO RELATED APPLICATIONS

The present application claims priority from Japanese patent application JP 2017-052074 filed on Mar. 17, 2017, the content of which is hereby incorporated by reference into this application.

### BACKGROUND

### Technical Field

The present disclosure relates to a method for forming resin film by melting resin, extruding the molten resin through a die, and forming the resin film while drawing the resin by a cooling roll.

### Background Art

Molten resin extruded from the exit of a die comes into contact with a cooling roll located below. The shape of the molten resin is defined on the free surface in a space from the exit of the die to the cooling roll, and the resin is deformed there in elongation flow so that the thickness decreases from 500 μm to 3 μm, for example. During this process, the molten resin may show the behavior called neck-in, resulting in a narrowed width of the resin film to be formed.

Due to this neck-in, both ends of the resin film become relatively thicker than a center part. Therefore such a relatively thick region at both ends of the resin film is trimmed for removal, and then the resin film as the final product is rolled. Resin film having considerable neck-in, therefore, becomes narrower in width inevitably, and the trimming amount of resin for removal increases. In this way, the raw-material resin as waste increases, which becomes a cause of degrading the utilization of the material.

Specifically such neck-in of the molten resin occurs after the molten resin extruded from the exit of the die comes into contact with the cooling roll and before the resin is cooled there for solidification.

More precisely, this neck-in results from a difference in flow morphology of the resin molten as follows. Molten resin has flow morphology such that a center part in the width direction of the resin film, which is a part fixed in width, shows planar elongation flow. In this flow, force acts on the film in the width direction as well as in the longitudinal direction orthogonal to the width direction.

On the contrary, the resin film at both ends has flow morphology that is uniaxial elongation flow, and the film can contract freely there. The resin film at both ends therefore receives the force from such a flow as well as the force of the flow in the width direction in the planar elongation flow at the center part in the width direction. Therefore neck-in occurs at the resin film. Such neck-in causes non-uniform distribution in thickness in the width direction of the resin film, and the resin film becomes thicker at both ends because the film contracts freely at both ends.

In addition, both ends of the resin film may be thinner at the border between the uniaxial elongation flow and the planar elongation flow at the center part because of tensile forces from both of the flows.

The resin film product manufactured by a conventional film-formation method has a maximum width as a result of the trimming of the part having non-uniform thickness at both ends, and so has a problem of poor utilization of the material as described above.

This neck-in can be suppressed by blowing air to both ends of the molten resin immediately before the molten resin reaches the cooling roll so as to cool the resin film there. JP 2002-331571A discloses a method for manufacturing thermoplastic film, and both ends of the film are cooled by an air nozzle between the exit of the die and the cooling roll so that the temperature of the thermoplastic resin there is the glass-transition temperature (Tg) or lower.

### SUMMARY

According to JP 2002-331571 A, such a method for manufacturing thermoplastic film can suppress neck-in without degrading the yield.

The present inventors, however, found that such cooling at both ends of the molten resin by air blowing results in an inside region of the resin close to the both ends being too thin while a more inside region of the resin being too thick conversely, and an appropriate thickness cannot be obtained at a center part of the molten resin in the width direction.

Therefore although the amount of neck-in can be decreased by cooling the molten resin at both ends by air blowing, the width (effective width) of the resin film having an appropriate thickness is still narrow, and the problem of poor utilization of the material is not solved.

In view of the above problems, the present disclosure provides a method for forming resin film capable maximizing the effective width of the resin film formed while suppressing neck-in and so increasing the utilization of the material.

A method for forming resin film according to the present disclosure includes: drawing molten resin extruded downward from an exit of a die by a rotating cooling roll located below the exit; blowing air to both ends of the molten resin from an air-blowing nozzle to cure the both ends of the molten resin while cooling the molten resin on a surface of the cooling roll for solidification to form the resin film. For an effective width of the resin film to be formed having a thickness in a predetermined thickness range, a target effective width is set, an amount of air to be blown and a distance from the air-blowing nozzle to the molten resin are set as conditions to form the resin film having an effective width of the target effective width or more, and the resin film is formed while blowing air under the conditions.

The method for forming resin according to the present disclosure has a feature that for a width (effective width) of the resin film to be formed having a thickness in a predetermined thickness range, a target effective width is set, an amount of air to be blown to both ends of the molten resin before reaching the cooling roll and a distance from the air-blowing nozzle to the molten resin are set as conditions to form the resin film having an effective width of the target effective width or more, and the resin film is formed while blowing air under the conditions.

This is based on the result of the experiment by the present inventors. Through the experiment, the present inventors found that, in addition to simply blowing air to the molten resin to suppress neck-in by cooling both ends of the molten resin, the amount of air to be blown and the distance between the air-blowing nozzle and the molten resin are very important factors to maximize the effective width of the molten resin.

In this way, the amount of air to be blown and the distance between the air-blowing nozzle and the molten resin are preferably set, and then air is blown to the resin. As a result, although the degree of suppressing neck-in is limited, unevenness in thickness on the inside of both ends of the resin film can be suppressed or removed, so that the resin film can have a large effective width.

The “predetermined thickness range” is not limited especially, and the range may be set between 2 μm to 5 μm, preferably between about 2 μm to 4 μm.

The “target effective width” is not limited especially. For instance, since the width of the molten resin before solidification on the surface of the cooling roll is reduced because of neck-in, about 80% of the width of the exit of the die can be set for the target effective width of the resin film.

Preferably, the amount of air to be blown and the distance from the air-blowing nozzle to the molten resin are changed variously relative to the set target effective width to form resin film to form resin film for trial so as to specify conditions of the amount of air to be blown and the distance from the air-blowing nozzle to the molten resin to form resin film having an effective width of the target effective width or more, and resin film is formed while blowing air under the specified conditions.

The amount of air to be blown and the distance from the molten resin may vary with the width of the exit of the die and the target effective width. Therefore preferably these two conditions are variously changed prior to the film formation so as to find the conditions to form resin film having the target effective width.

Preferably, conditions to form resin film having an effective width of the target effective width or more further include: in addition to the amount of air to be blown and the distance to the molten resin, a width of an opening region of the air-blowing nozzle; a width-direction distance between a width-direction end of the exit of the die and a width-direction end of the opening region of the air-blowing nozzle located inside of the width-direction end of the exit of the die; a downward distance along a moving direction of the molten resin between the exit of the die and a vertical center of the opening region of the air-blowing nozzle located below the exit; and an angle between the air-blowing nozzle and the molten resin that is being drawn by the cooling roll.

The present inventors found that by the method for forming film of the present disclosure, the target effective width can be set at 543 mm when the width of the exit of the die is 600 mm. This means about 90% of the utilization of the material, and so very high utilization of the material can be achieved.

The present inventors found that, when the width of the exit of the die is 600 mm and the target effective width is set at 543 mm, the amount of air to be blown that is 1.3 L/min. and the distance from the molten resin that is 3.4 mm are the conditions to realize this target effective width.

The present inventors further found that, in this case, the width of the opening region of the air-blowing nozzle is 26 mm, the width-direction distance is 28.8 mm, the downward distance is 20 mm, and the angle between the molten resin and the air-blowing nozzle when drawing the molten resin by the cooling roll is 80 degrees that is an acute angle on a side of the die.

As can be understood from the above description, the method for forming resin film of the present disclosure sets a target effective width for a width (effective width) of the resin film having a thickness in a predetermined thickness range, and forms film while blowing air under the conditions of the amount of air to be blown to both ends of the molten resin before reaching the cooling roll and of the distance between the air-blowing nozzle and the molten resin that are set to form the resin film having an effective width of the target effective width or more. This enables suppression of neck-in and a maximized effective width of the resin film, and so can increase the utilization of the material.

### BRIEF DESCRIPTION OF THE DRAWINGS

FIG. 1 schematically shows a method for forming resin film according to the present disclosure as well as an apparatus for forming film;

FIG. 2 is a view from the direction of arrow I in FIG. 1;

FIG. 3 is a view from the direction of arrow II in FIG. 1;

FIG. 4 is a perspective view of one embodiment of an air-blowing nozzle;

FIG. 5A shows the relationship between the width of molten resin extruded from the exit of the die and the width of the resin film in a conventional method for forming film by air blowing; and

FIG. 5B shows the relationship between the width of molten resin extruded from the exit of the die and the width of the resin film in the method for forming film of the present disclosure.

### DETAILED DESCRIPTION

The following describes one embodiment of a method for forming resin film according to the present disclosure as well as an apparatus for forming film, with reference to the drawings. Although the drawings show an example of integrating formed resin film and a back sheet and then rolling the integrated sheet, the formed resin film only may be rolled.

(Embodiment of a Method for Forming Resin Film)

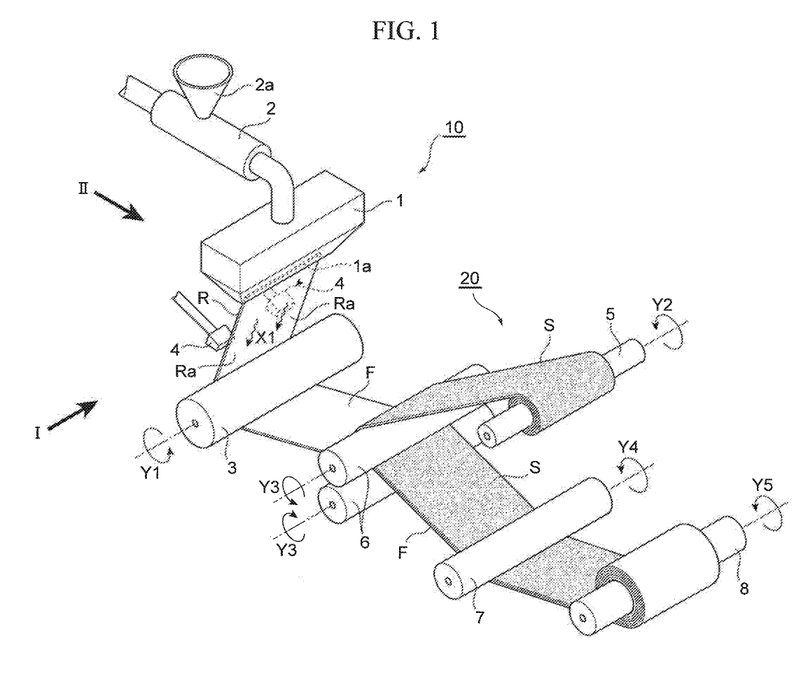

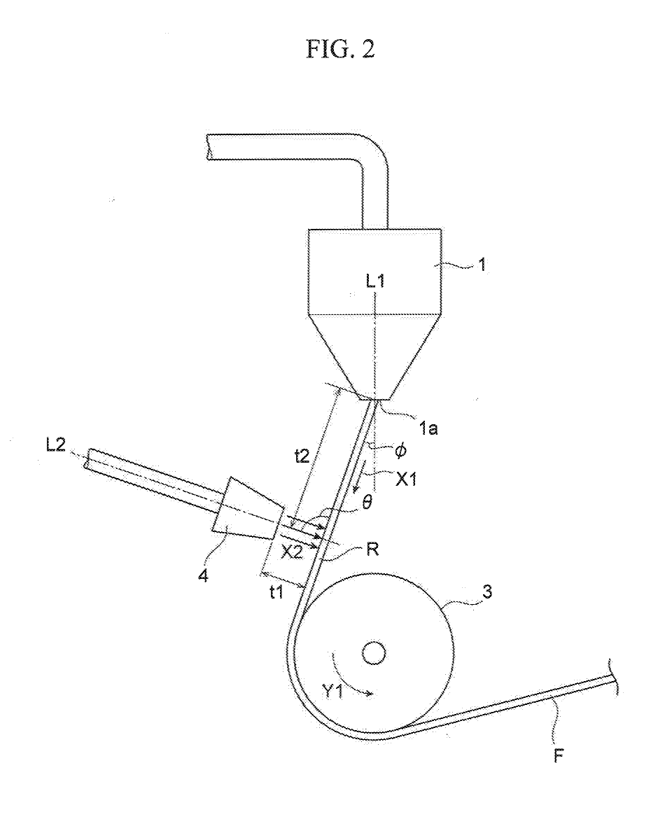

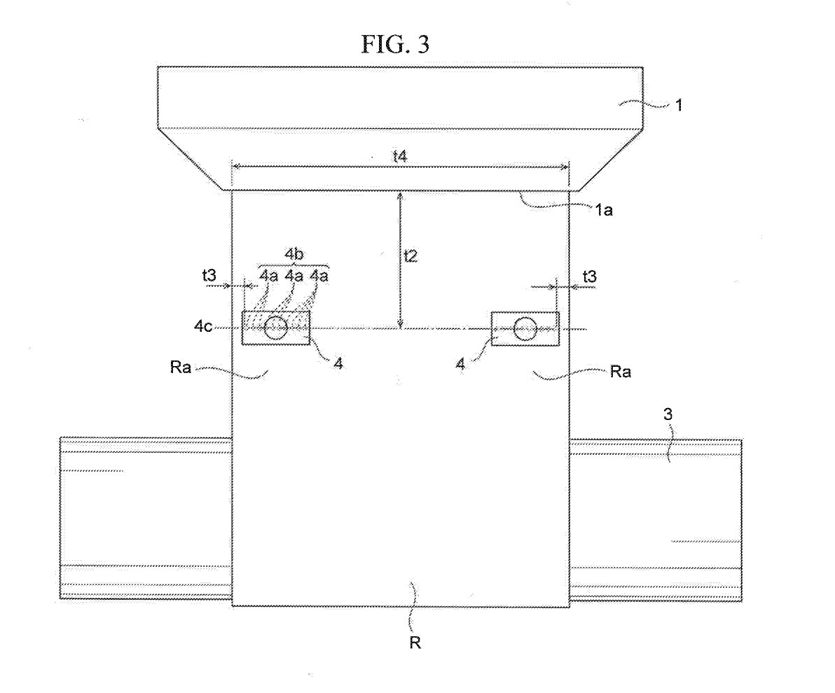

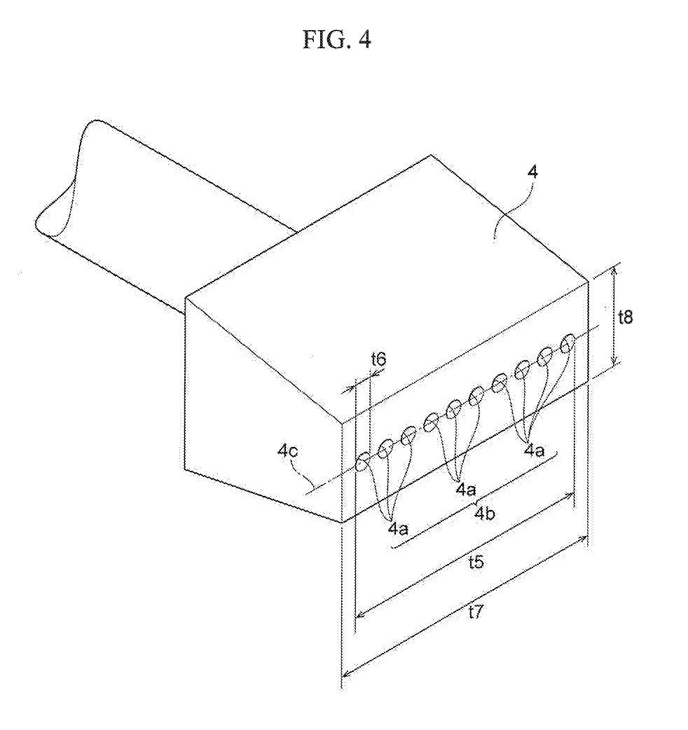

FIG. 1 schematically shows a method for forming resin film according to the present disclosure as well as an apparatus for forming film. FIG. 2 is a view from the direction of arrow I in FIG. 1 and FIG. 3 is a view from the direction of arrow II in FIG. 1. FIG. 4 is a perspective view of one embodiment of an air-blowing nozzle.

FIG. 1 shows a film-formation apparatus 10 to form resin film F from molten resin R, and a sheet manufacturing apparatus 20 to integrate the formed resin film F and a back sheet S to manufacture a sheet.

The film-formation apparatus 10 roughly includes an extruder 2, a die 1 having an exit 1a of a predetermined width at the lower end, a cooling roll 3 located below the die 1 to cool the molten resin R extruded from the exit 1a, and two air-blowing nozzles 4 located between the exit 1a and the cooling roll 3 to blow air to the molten resin R at both ends Ra for cooling.

The extruder 2 internally includes an agitation screw not illustrated. Resin pellets not illustrated inserted from a hopper 2a are heated to be molten in the extruder 2, and the molten resin agitated by the agitation screw passes through the die 1 in communication with the extruder and is extruded from the exit 1a downward to have a predetermined width. The speed of drawing the molten resin R by the rotation of the cooling roll 3 is set higher than the speed of extruding the molten resin R from the exit 1a, whereby the thickness of the molten resin R extruded from the exit 1a can be thinner.

The molten resin R is extruded downward (X1 direction) while being tilted by angle ϕ relative to the (vertical) center line L1 of the exit 1a of the die 1, and then is drawn by the cooling roll 3 that is located below the exit 1a and is rotary-driven by a driving motor not illustrated in Y1 direction. Then, the molten resin R is cooled and solidified on the surface of the cooling roll 3, whereby resin film F is formed.

Before the molten resin R reaches the cooling roll 3, the two air-blowing nozzles 4 blow a predetermined amount of air to both ends Ra of the molten resin R along X2 direction toward the molten resin R, whereby neck-in of the molten resin R can be suppressed.

This resin film F to be formed has an effective width having a thickness in a predetermined film-thickness range. Then, a target effective width for the effective width is set to form the resin film F.

To form the resin film F having an effective width that is the set target effective width or more, at least two conditions are set as follows.

One of the conditions is the amount of air to be blown, and the other condition is a distance from the air-blowing nozzle 4 to the molten resin R (t1 in FIG. 2).

To set these conditions, the amount of air to be blown and the distance t1 between the air-blowing nozzle 4 and the molten resin R are changed variously for trial to achieve the set target effective width. Through such trial to form the resin film F, the amount of air to be blown and the distance t1 may be specified so as to form the resin film F having an effective width that is the target effective width or more.

Additionally other conditions may be set, whereby the accuracy to form the resin film F with an effective width that is the target effective width or more can be improved.

Specifically as shown in FIGS. 2 to 4, the other conditions include: the downward distance t2 along the moving direction (X1 direction) of the molten resin R between the exit 1a of the die 1 and a vertical center 4c of an opening region 4b that is the combination of regions of a plurality of circular openings 4a at the air-blowing nozzle 4; the width t4 of the exit 1a; the distance in the width-direction t3 between each end of the molten resin R and the corresponding end in the width direction of the opening region 4b of the air-blowing nozzle 4; the width t5 of the opening region 4b of the air-blowing nozzle 4; and the angle θ between the air-blowing nozzle 4 and the drawing direction of the molten resin R by the cooling roll 3 (the angle between the molten resin R and the center line L2 of the circular opening 4a of the air-blowing nozzle 4).

To form the resin film F having an effective width of the target effective width or more, various conditions including the amount of air to be blown and the distance t1 between the air-blowing nozzle 4 and the molten resin R are set as described above. The experiment by the present inventors as described later shows that, by setting these various conditions, the effective width of the resin film F formed can be maximized while suppressing neck-in, and the utilization of the material can be increased to about 90%.

For the air-blowing nozzle 4, a nozzle with ten circular openings 4a of t6 in diameter at the leading end as shown in FIG. 4 may be used, and the front face of the nozzle has a rectangular shape of t7 in width and t8 in thickness. Instead of the plurality of circular openings 4a, the air-blowing nozzle may have a horizontally-long slit.

For instance, when the width t4 of the exit 1a of the die 1 is 600 mm and the target effective width is set at 543 mm that is about 90% of the width, the present inventors found that conditions to realize the resin film F having this effective width are the amount of air to be blown that is 1.3 L/min. and the distance t1 from the air-blowing nozzle 4 and the molten resin R that is 3.4 mm.

Then, the width t5 of the opening region 4b of the air-blowing nozzle 4 is set at 26 mm, the distance in the width-direction t3 is set at 28.8 mm, and the downward distance t2 is set at 20 mm. This can yield the utilization of 90% more reliably. At this time, the width t7 of the air-blowing nozzle 4 may be set at 35 mm, the thickness t8 of the air-blowing nozzle may be 10 mm, the diameter t6 of the plurality of circular openings 4a may be set at 1 mm, and the angle ϕ of the molten resin R extruded from the exit 1a of the die 1 relative to the vertical below may be set at 20 degrees.

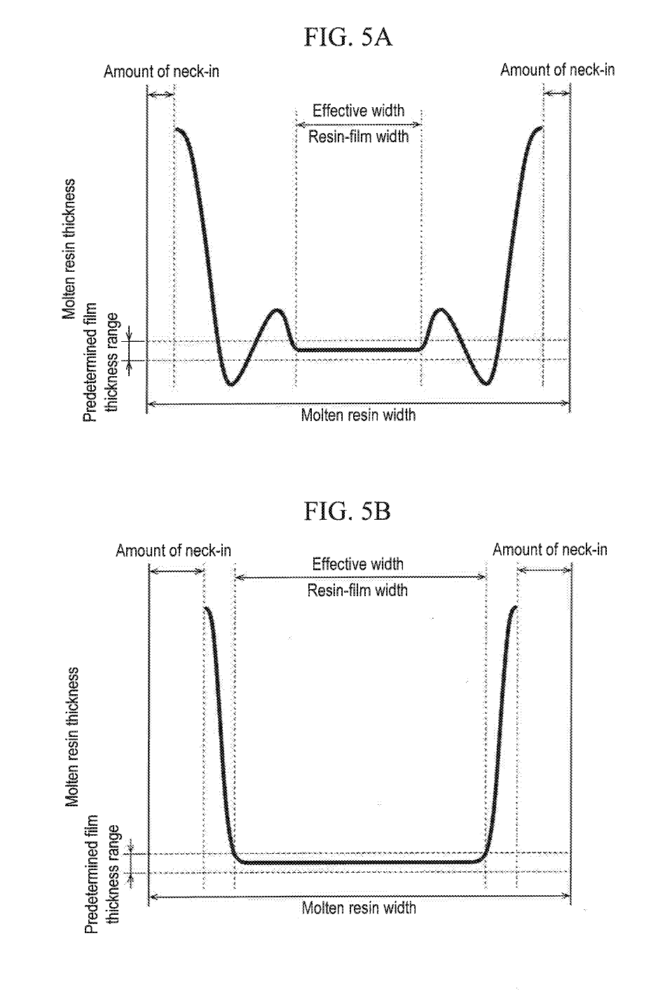

FIG. 5A shows the relationship between the width of molten resin extruded from the exit of the die and the width of the resin film in a conventional method for forming film by air blowing. FIG. 5B shows the relationship between the width of molten resin extruded from the exit of the die and the width of the resin film in the method for forming film of the present disclosure. In the conventional film-formation method, air is blown to minimize the amount of neck-in without considering the thickness of the molten resin at all.

Comparison between FIGS. 5A and 5B shows that the effect of suppressing the amount of neck-in decreases in the film-formation method of the present disclosure as compared with the conventional film formation method.

In the conventional film-formation method, however, the range of effective width having a film thickness in the predetermined thickness range is very small. This is because the thickness of the molten resin is unevenness. That is, although the thickness reduces sharply from the end of the molten resin to a thickness less than the predetermined thickness range, the thickness conversely increases on the inside in the width direction to exceed the predetermined thickness range and then can be within the predetermined thickness range on the more inside in the width direction.

On the contrary, according to the film-formation method of the present disclosure, although the amount of neck-in cannot be suppressed well as in the conventional method, the range of the effective width having a thickness in the predetermined thickness range can increase considerably because various conditions, such as the amount of air to be blown and the distance between the air-blowing nozzle and the molten resin, are set appropriately, and so the unevenness of the thickness can be removed or decreased on the inside of both ends of the molten resin.

Referring back to FIG. 1, the resin film F formed by solidifying the resin on the surface of the cooling roll 3 is sent to between two nip rolls 6 of the sheet manufacturing apparatus 20. The nip rolls are opposed and rotate in Y3 direction so as to pull the resin film F. Back sheet S is sent from a reel-off shaft 5 rotating in Y2 direction, and this back sheet also is sent to between the two nip rolls 6. At the nip rolls, the resin film F and the back sheet S are overlapped and receive pressure between the nip rollers 6 for integration. Thereby a sheet can be manufactured. The thus manufactured sheet is wound around a winding shaft 8 that is rotary-driven by a not-illustrated driving motor in Y5 direction via a free roll 7 that can rotate freely in Y4 direction.

(Experiment to Verify Utilization of the Material and the Result)

The present inventors formed resin sheet by the film-formation method in the following Example and the film-formation method in the following Comparative Example. Both of Example and Comparative Example were formed by the film-formation apparatus shown in FIGS. 1 to 4, and the experiment was conducted by changing the various conditions.

### Conditions of Example

The material used was electrolyte resin having a F-type terminal group. The resin had the flow-starting temperature at 170 to 190° C., and the rigidity modulus G during extrusion for film-formation was 1×10⁴ to 1×10⁵ Pa in the range of 210 to 260° C. The conditions for extrusion from the die were as follows. The temperature of the die was 240° C. The width of the exit of the die was 600 mm. The lip gap of the die was 500 μm. The angle of the molten resin extruded from the exit of the die was 20 degrees relative to the vertical below. For the air-blowing nozzle, the distance from the molten resin was 3.4 mm, the downward distance was 20 mm, the amount of air to be blown was 1.3 L/min., the air temperature was 25° C., the angle of the molten resin and the air-blowing nozzle was 80 degrees that was an acute angle on the side of the die, the width of the opening region of the air-blowing nozzle was 26 mm, and the distance in the width-direction was 28.8 mm. For other conditions, the temperature of the cooling roll was 40° C., the velocity to convey the resin film by the cooling roll was 12 m/min., and the thickness of the resin film to specify the target effective width was 3 μm.

### Conditions of Comparative Example

The material used was electrolyte resin having a F-type terminal group. The resin had the flow-starting temperature at 170 to 190° C., and the rigidity modulus G during extrusion for film-formation was 1×10⁴ to 1×10⁵ Pa in the range of 210 to 260° C. The conditions for extrusion from the die were as follows. The temperature of the die was 240° C. The width of the exit of the die was 600 mm. The lip gap of the die was 500 μm. The angle of the molten resin extruded from the exit of the die was 20 degrees relative to the vertical below. For the air-blowing nozzle, the distance from the molten resin was 5.9 mm, the downward distance was 20 mm, the amount of air to be blown was 2.3 L/min., the air temperature was 25° C., the angle of the molten resin and the air-blowing nozzle was 80 degrees that was an acute angle on the side of the die, the width of the opening region of the air-blowing nozzle was 26 mm, and the distance in the width-direction was 28.8 mm. For other conditions, the temperature of the cooling roll was 40° C., the velocity to convey the resin film by the cooling roll was 12 m/min., and the thickness of the resin film to specify the target effective width was 3 μm.

<Result of Experiment>

Whereas the initial width of the molten resin corresponding to the width of the exit of the die was 600 mm, the effective width of Comparative Example was 438 mm, and the utilization of the material was 73%.

On the contrary, the effective width of Example was 543 mm, and the utilization of the material was 90.5%. In this way, the utilization of the material was improved considerably as compared with Comparative Example. For such improvement, the conditions including the amount of air to be blown that was 0.1.3 L/min. and the distance from the molten resin that was 3.4 mm were especially effective. Other conditions, including the downward distance that was 20 mm, the width of the opening region of the air-blowing nozzle that was 26 mm, the distance in the width-direction that was 28.8 mm, and the angle of the molten resin and the air-blowing nozzle that was 80 degrees so that the angle on the side of the die, also presumably contributed to the improvement.

While certain embodiments of the present disclosure have been described in details with reference to the drawings, the specific configuration is not limited to the above-stated embodiments, and it should be understood that the present disclosure covers design modifications without departing from the spirits and scope of the present disclosure.

### DESCRIPTION OF SYMBOLS

1 Die
1a Exit
2 Extruder
2a Hopper
3 Cooling roll
4 Air-blowing nozzle
5 Reel-off shaft
6 Nip roll
7 Free roll
8 Winding shaft
10 Film-formation apparatus
20 Sheet manufacturing apparatus
R Molten resin
Ra End (both ends)
F Rein film
S Back sheet

What is claimed is:

1. A method for forming resin film, comprising: drawing molten resin extruded downward from an exit of a die by a rotating cooling roll located below the exit; blowing air to both ends of the molten resin from an air-blowing nozzle to cure the both ends of the molten resin while cooling the molten resin on a surface of the cooling roll for solidification to form the resin film, wherein
for an effective width of the resin film to be formed having a thickness in a predetermined thickness range, a target effective width is set, an amount of air to be blown and a distance from the air-blowing nozzle to the molten resin are set as conditions to form the resin film having an effective width of the target effective width or more, and the resin film is formed while blowing air under the conditions.

2. The method for forming resin film according to claim 1, wherein the amount of air to be blown and the distance from the air-blowing nozzle to the molten resin are changed variously relative to the set target effective width to form resin film for trial so as to specify conditions of the amount of air to be blown and the distance from the air-blowing nozzle to the molten resin to form resin film having an effective width of the target effective width or more, and resin film is formed while blowing air under the specified conditions.

3. The method for forming resin film according to claim 1, wherein conditions to form resin film having an effective width of the target effective width or more further include: a width of an opening region of the air-blowing nozzle; a width-direction distance between a width-direction end of the exit of the die and a width-direction end of the opening region of the air-blowing nozzle located inside of the width-direction end of the exit of the die and; a downward distance along a moving direction of the molten resin between the exit of the die and a vertical center of the opening region of the air-blowing nozzle located below the exit; and an angle between the air-blowing nozzle and the molten resin that is being drawn by the cooling roll.

4. The method for forming resin film according to claim 3, wherein the exit of the die has a width of 600 mm, and the target effective width is set at 543 mm.

5. The method for forming resin film according to claim 4, wherein the amount of air to be blown is 1.3 L/min. and the distance from the molten resin is 3.4 mm.

6. The method for forming resin film according to 5, wherein the width of the opening region of the air-blowing nozzle is 26 mm, the width-direction distance is 28.8 mm, the downward distance is 20 mm, and the angle is 80 degrees that is an acute angle on a side of the die.
